(19) United States
(12) Patent Application Publication
(10) Pub. No.: US 2005/0132269 A1
(43) Pub. Date: Jun. 16, 2005

(54) Method for retrieving image documents using hierarchy and context techniques

(75) Inventor: Amit Chakraborty, Cranbury, NJ (US)

Correspondence Address: Elsa Keller;Siemens Corporation, Intellectual Property Department, 170 Wood Avenue South, Iselin, NJ, 08830, US

(73) Assignee: Siemens Corporate Research, Inc.

(21) Appl. No.: 10/732,004

(22) Filed: Dec. 10, 2003

(51) Int. Cl. G06F 17/24

(52) U.S. Cl. 715/513

(57) ABSTRACT

Hierarchical image organization methods and database mapping methods are used to translate queries to relevant context based search strategies. Once the intended results are retrieved, further refining can be achieved by making use of direct image descriptors and relevance feedback. Once the intended results are obtained, further refining can be achieved by making use of direct image descriptors and relevance feedback.

### TECHNICAL FIELD

The present invention is directed to a method of associating a text Extensible Markup Language (XML) file with an image and, more particularly, to a method of retrieving image documents using hierarchy and context techniques.

### BACKGROUND OF THE INVENTION

With the rapid development of information technologies, the amount of multimedia information increases explosively. Therefore, effective tools to search and browse the large collection of multimedia data, especially images, have attracted much attention. The search techniques for images are a common ground for video search as well, because video is often represented by several key frames. The greatest challenges in image and video search result from the gap between the low-level representation and the underlying high-level concept in visual information. While the computer understands images with the low-level features (visual feature) such as color, texture, and shape, human perceives images semantically; that is, based on the semantics or true meaning of content. However, it is very difficult to directly extract the semantic level features from images with the current technology in computer vision and image understanding.

Content based image retrieval is considered to be one of the promising areas of research and development in the area of image databases. However, the primary way it has been handled so far is either through the use of keywords that are associated with the drawings that then are used for the retrieval using traditional Database Management System (DBMS) technology or directly by matching image features such as color, texture, etc. However, neither of these methods is able to mimic the way humans retrieve information regarding a visual object where contexts such as the background, time and information other than just the characteristics of the image are of importance.

In addition, various methods have been tried including repeated relevance feedback, where the user comments on the items retrieved. The user's query provides a description of the desired image or class of images. The description can take many forms; it can be a set of keywords in the case of an annotated image database, or a sketch of an image or an example image or a set of values that represent quantitative pictorial features such as overall brightness, percentages of pixels of specific colors, etc. Unfortunately however, users often have difficulty specifying such descriptions, in addition to the difficulties that the computer programs have in understanding them. Moreover even if the user provides a good initial query, the problem remains of how to navigate through the database.

The challenge is to be able to map the original low level visual feature space into a space reflecting high level concept by the user. Thus the performance of the retrieval system is dependant on the model of the learning structure and adaptation from the user feedback. Several retrieval systems use the uni-modal model for the high level similarity metric, i.e. the next query point is the estimated location of the image which is most similar to the target image and the similarity of other images decreases as the distance to this point increases. However, this model is not adequate to uncover the user desired high-level semantics. Basically semantics based search is a kind of category search; the user searches images that belong to a prototypical category such as flowers, animals and the like.

While all of the above methods serve certain intended purposes and go a level to make the query human-like, they still fall far short making the query as organized as they should be and what often is subconsciously done in human mind as we go looking for a certain image from a collage. What is important is to be able to give the user the ability to make context based searches possible and organize images in a hierarchical manner. Further we also envision images to be described by their subcomponents and the association in between them.

For instance there might be a query that looks for a baby lion or a more qualified one that looks for a baby lion in the Bronx Zoo. Now the database has to be organized in such a way that the response is quick and accurate. If the images are annotated properly it is possible that one can match the queries, but without any structure, the retrieval time can possibly be large. Also, without any further qualification even an annotated query might fail as it is likely to bring up images of say a baby lion that once visited the Bronx Zoo or the baby lion that was raised in the Bronx Zoo or the baby lion that is in the Bronx zoo. Clearly our target is the last one. As for matching direct image descriptors, it is also a difficult task, as one can sketch a baby lion and may even be right regarding the details of the body color, but one can never be certain what the pose and lighting is and the background that would make the search very difficult, if not impossible without higher level semantic organization. This is a simple enough query but it still details the challenges faced by traditional search methods.

### SUMMARY OF THE INVENTION

The present invention uses hierarchical image organization methods and database mapping methods that translate queries to relevant context based search strategies. Once the intended results are retrieved, further refining can be achieved by making use of direct image descriptors and relevance feedback.

A method of creating an Extensible Markup Language (XML) file that is associated with an image document is disclosed. A Document Type Definition (DTD) is created that defines a hierarchy for the XML file. An image classification for the image document is obtained. Image analysis processes are used to extract dominant parameters of the image document. An image category for the image document is identified. At least one image sub-category for the image document is identified. Objects from the image are extracted, and an XML file is created to store all of the information.

The present invention is also directed to a method for querying Extensible Markup Language (XML) files to search for one or more image documents. A context-based query for an image document is received. The context-based query is converted to an XPath query. The XPath query is mapped to a Structured Query Language (SQL) string. One or more image documents are searched for using the SQL string. One or more image documents are retrieved that match criteria in the SQL string and displayed to a user.

### BRIEF DESCRIPTION OF THE DRAWINGS

Preferred embodiments of the present invention will be described below in more detail, wherein like reference numerals indicate like elements, with reference to the accompanying drawings:

FIG. 1 is a block diagram of an exemplary network architecture in accordance with the present invention;

FIG. 2 is a systematic flow diagram illustrating how a database is created and organized in accordance with the present invention;

FIG. 3 is a systematic flow diagram illustrating how a qualifying XML file for an image document is created;

FIG. 4 is a systematic flow diagram illustrating how an image document is queried in accordance with the present invention; and

FIG. 5 is a systematic flow diagram illustrating further how an image document is queried in accordance with the present invention.

### DETAILED DESCRIPTION

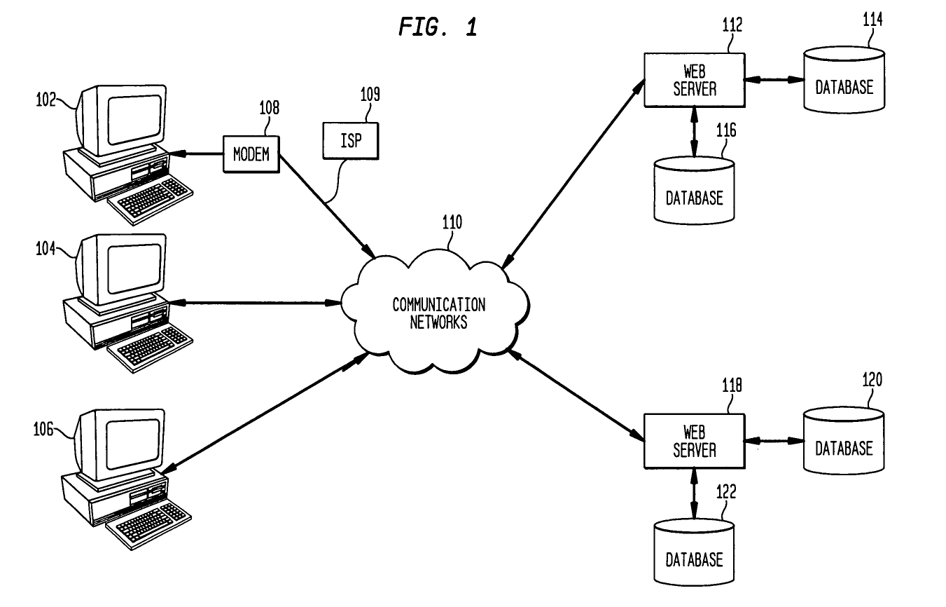

The present invention is directed to a method of retrieving image documents using hierarchy and context techniques. FIG. 1 illustrates an exemplary network architecture for implementing the present invention. Personal Computers (PC) 102, 104, 106 may be part of a Local Area Network (LAN) or independently connected to communication networks 110. It is to be understood by those skilled in the art that the personal computers 102, 104, 106 may connect to the communication networks 110 in a number of different ways. For example, PC 102 may use a modem 108 to connect to an Internet Service Provider (ISP) 109 which connects PC 102 to the communication networks 110. Modem 108 may be a dialup modem, a cable modem or a modem used for Digital Subscriber Lines (DSL) that allows PC 102 to connect to communication network. Communication Networks 110 may be a single network or a combination of networks such as the Public Switched Telephone Network (PSTN), cable network, Digital Subscriber Lines (DSL), the Internet or an intranet.

The communication networks 110 connect to one or more web servers 112, 118. The web servers 112, 118 may be, for example, SPARC stations manufactured by Sun Microsystems, Inc. Each web server may host one or more web sites. Associated with each web server 112, 118 are one or more databases 114, 116, 120, 122 that contain multimedia data. This data may include text documents, image documents, XML documents and other media. It is to be understood by those skilled in the art that the number of PCs, web servers and databases shown in FIG. 1 are merely for illustrative purposes and that the number of PCs web servers and databases that are included in the network may be significantly more than shown.

In accordance with the present invention, a user of a PC may make a request for an image document over the communication networks to one or more of the web servers. Alternatively, the user may request a document resident on his or her PC or contained within a LAN of PCs. The image request can be made as a text request, a context request or a combination of both types of requests.

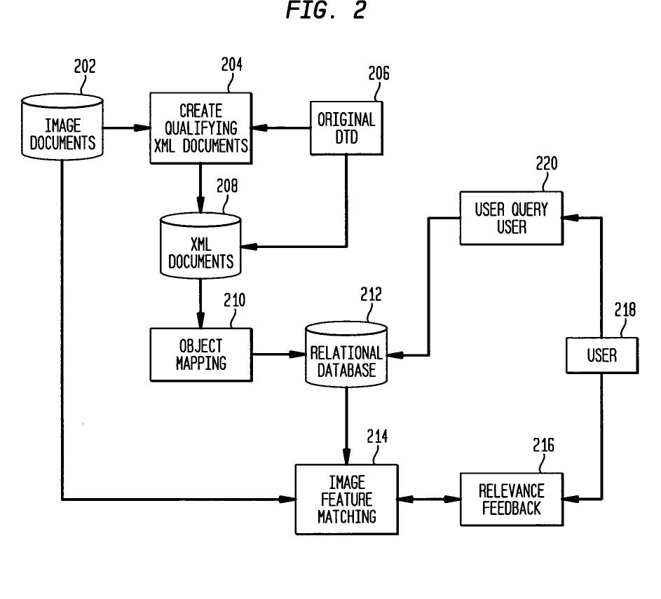

FIG. 2 illustrates a process for organizing image documents 202 and associating the image documents with XML documents 208. As will be described in detail hereinafter, the XML documents 208 follow a grammar that defines the hierarchies and description syntax of the image documents using a Document Type Definition (DTD) 206. The complexity of the DTD will be defined by the complexity of the underlying application and the image database in question.

Once a DTD has been selected, the next step would be to associate qualifying XML documents 204 with each or a group of images which in essence describes the image, its position in the hierarchy, the content of it in a certain format and other features as defined by the DTD. These XML documents are then mapped 210 to a relational database 212 for querying later.

On the query side, the first step would be to take a natural or user query 220 and map it into a relational statement that can be understood and interpreted. Following that, the actual query is done on the XML part of the database that locates the image files. Now, once multiple matches 214 are found, the query is refined using further qualifiers that directly act on the image descriptors such as color, texture etc. If there are still multiple matches, relevance feedback 216 is used to refine further and hone in to the actual target image.

As indicated above, an important aspect of the present invention is the DTD. A Document Type Definition (DTD) is created that defines the syntax for the hierarchy and the language for the characterization that will be used to define the XML file that gets associated with the image document. Clearly, search performance is improved if the DTD is very structured and well defined. However, the choice of the DTD and the associated complexity should clearly be defined by the complexity of the underlying image database and the natural categorization that it may or may not fall into. It is also preferable that the DTD be scaleable so that the DTD can adapt as more data is created, and more categorization needs to be done, without having to change the DTD.

An embodiment of an exemplary DTD will now be described. The root element in the XML file is identified as AIUDoc, which in turn consists of three elements, DocHeader, ImageDocX and DocFooter as follows:

| <!ELEMENT | AIUDoc | --(DocHeader, ImageDocX, DocFooter)> | |
|---|---|---|---|
| <!ATTLIST | AIUDoc | | |
| | Id | CDATA | #IMPLIED |
| | Type | CDATA | #IMPLIED |
| | Name | CDATA | #IMPLIED |
| > | | | |

The definition of the DocHeader, which contains the name of the Image file, is as follows:

| <!ELEMENT | DocHeader | --(DocType, DocDesc)> | |
|---|---|---|---|
| <!ATTLIST | DocHeader | | |
| | Name | CDATA | #IMPLIED |
| | File | CDATA | #IMPLIED |

The definition of the DocFooter, is as follows:

| | | |
|---|---|---|
| <!ELEMENT | DocFooter | (#PCDATA)> |

In accordance with the present invention, the key definition is that of the ImageDocX. Besides category and classification it includes information regarding objects and their location either relative or absolute and also information such as if a particular object is in the foreground or background. Since the number of categories and subcategories are dependent on the application, the DTD definition needs to accommodate recursion. The definition of ImageDocX is as follows:

| | | |
|---|---|---|
| <!ELEMENT | ImageDocX | (Author?, Date?, ImageClass)> |
| <!ELEMENT | Author | (#PCDATA)> |
| <!ELEMENT | Date | (#PCDATA)> |
| <!ELEMENT | ImageClass | (ImageCategory?, #PCDATA)> |
| <!ATTLIST | ImageClass | |

| | | |
|---|---|---|
| Texture_Parameters | CDATA | #IMPLIED |
| Color_Parameters | CDATA | #IMPLIED |

| | | |
|---|---|---|
| <!ELEMENT | ImageCategory | (ImageCategory?, ImageObject*, |
| #PCDATA)> | | |
| <!ELEMENT | ImageObject | (ImageObject*, #PCDATA)> |
| <!ATTLIST | ImageObject | |

| | | |
|---|---|---|
| Name | CDATA | #IMPLIED |
| Location | CDATA | #IMPLIED |
| Coordinates | CDATA | #IMPLIED |
| Reference | CDATA | #IMPLIED |

ImageDocX comprises the main definition in ImageClass, information regarding the author (painter, photographer etc.) and the image date. The ImageClass information comprises the ImageCategory element which is self-recursive, the cardinality dependent on the depth of the categorization. The ImageClass also has information regarding the texture and other raw image related information stored that can be generated using Image processing algorithms. It also has the ImageObject field which is repetitive and has attributes such as Name, Location which define whether that particular object is to the left or right or some other corner of the image, and it also has another attribute that defines the exact image coordinates if available. Reference defines if the object is at the foreground or at the background or is occluded. More information regarding the image can also be stored and there might be further elements and attributes created if necessary.

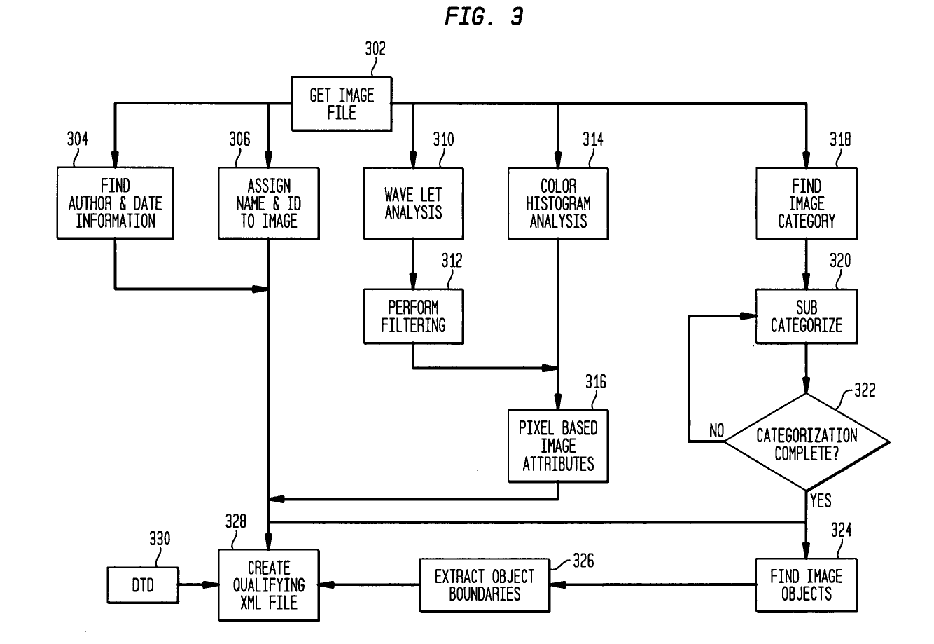

FIG. 3 illustrates the sequence of steps for creating an associated XML file that contains information regarding the images based on the syntax described above. An image file is retrieved (302) and information regarding the image is gathered either manually or automatically and stored in the associated XML file (328). Examples of the types of information gathered are the Image Classification (e.g., natural, man-made etc.), and the author and date information (304). Next, an ID and Name are assigned to the Image (306). Image analysis methods, such as wavelet analysis (310) and color histogram generation (314), are performed and the dominant parameters of the image are extracted and stored (312, 316).

Next, an image category (e.g., animals, plants, etc.) is identified for the image (318). Sub-categories (e.g., terrestrial, aquatic etc.) are created for each identified image category (320). Additional sub-categories within an image category are created as long as it is appropriate (322). Objects are extracted from the image (324). Objects are extracted manually or automatically using image processing algorithms such as boundary finding. In addition, object information is extracted (326). Examples of object information include attributes such as location, position, coordinates of the object etc. Once all of the image data and object information is gathered, an XML file is created to store all of this information relating to the particular image (328).

Consistent with the method described above and using the example of an image of a baby lion at the Bronx Zoo, an exemplary XML file associated with such an image would be as follows:

```
<AIUDoc Id=”NAIU5” Name=”lion”>
<DocHeader file=”bronxzoobabylion.gif”>
</Docheader>
<ImageDocX>
<Author>John Smith</Author>
<Date>12/12/1995</Date>
<ImageClass Texture_Parameters=”a1 a2 ....” Color_Parameters=
”b1 b2 .....”>
Natural
<ImageCategory> Animals
  <ImageCategory>Terrestrial
    <ImageCategory> Big Cats
      <ImageCategory> Lion
        <ImageObject Name=”babylion” Location=”center”
        Coordinates=”x1 y1 x2 y2 ..” Reference=”foreground”>
        A baby lion is in the foreground
        </ImageObject>
        <ImageObject Name=”Bronx zoo”
        Coordinates=”x1 y1 x2 y2 ..” Reference=”background”>
        The background of the picture is the Bronx Zoo
        </ImageObject>
    </ImageCategory>
  </ImageCategory>
</ImageCategory>
</ImageClass>
</ImageDocX>
</AIUDoc>
```

The present invention is directed to a method of creating a database that can query both the XML information and the image data. In an embodiment of the present invention, two databases are created. The first database comprises the image files and the second database comprises the XML files described above. The databases are generally created in the following manner. For an application under consideration, the DTD is simplified by identifying the necessary elements and attributes. Next, separate tables are associated with every element that has either children nodes or attributes. Primary and foreign keys are created to establish the relationship between the different tables. Element and attribute values are extracted from the XML files and used to populate the database.

The present invention is also directed to a method of taking a normal query and mapping it to the one that is suitable to the system. XML is a hierarchical language and lends itself to a very structured grammar for making queries. In order for the data structures and databases described above to work effectively with such queries, the queries are mapped to Structured Query Language (SQL) statements where appropriate and used to extract the appropriate entry from the document. There are several ways to query an XML document. One common standard for addressing parts of an XML document is Xpath. However, it is to be understood by those skilled in the art that other languages can be used to address parts of the XML document without departing from the scope and spirit of the present invention. Once the query results are received, if multiple images are selected, pixel-based image processing methods can be used to narrow down the search. Further filtering of the search results are achieved using relevance feedback.

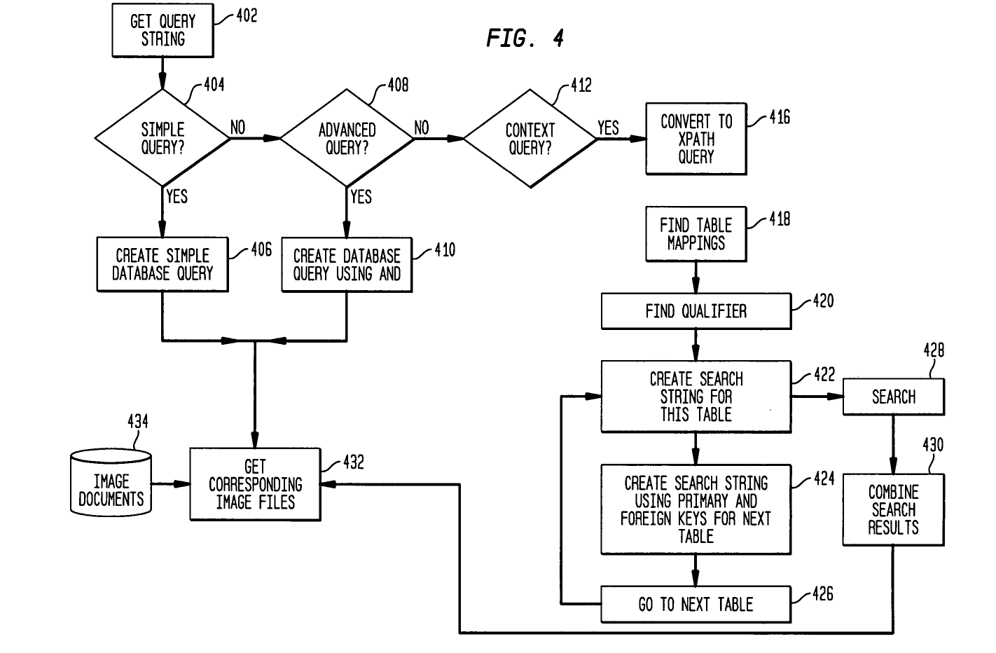

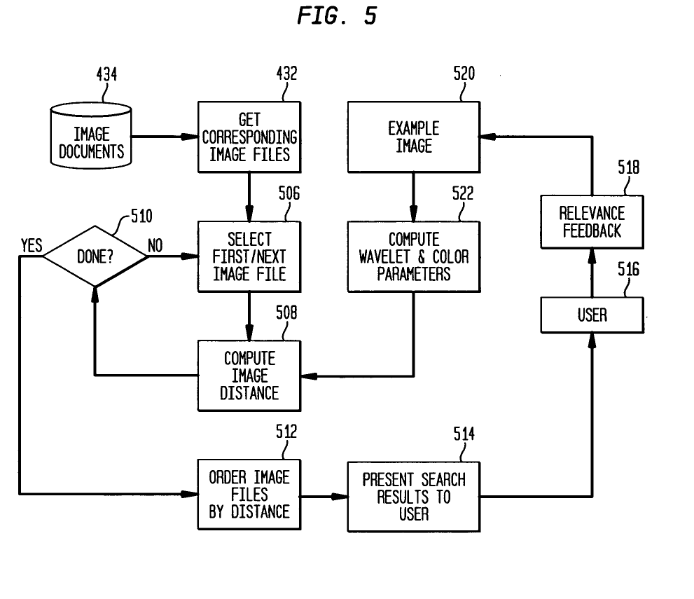

The method for performing a query of an XML document to obtain an image document is generally shown in FIGS. 4 and 5. First the query is received and the type of query is determined (402). If the query is a simple text query for a keyword (404), the query is mapped to a simple database query using the SELECT and WHERE clause and using OR to join searches from all the columns of all the tables (406). This works for the database part of the system. A text search is also performed for the rest of the system where the XML documents are stored. If there is a match, the whole subnode of the XML tree is extracted up to the match point.

If the query is an advanced search query where multiple fields from different columns are specified (408), the query is mapped it to a database search using a SELECT and WHERE clause and using AND to find the intersection of all searches (410). Once again this only takes care of the database mapped part of the system.

In accordance with the present invention, the most important search is that using an XPath statement. A context query is received (412). Most Context-based searches on the hierarchy of the data can be transformed to an XPath statement (416). These statements can either start at the root and follow all the way to specify the value of an element or an attribute or might just start at some point in the tree and specify the value of an element or attribute somewhere in the subtree. Thus the first step is to identify the location of the start tag in the query.

For example, in the case of the query that looks for a baby lion or a more qualified one that looks for a baby lion in the Bronx Zoo, the query can be framed as an XPath statement as follows:
//ImageCategory/[ImageCategory=“Lion”]/[ImageObject[contains(@Name,‘babylion’)] and ImageObject[contains(@Name,‘Bronx Zoo‘)]]

Once the XPath query is obtained, the XPath query is mapped to an SQL string (418). Reference is made to the DTD to determine how that particular hierarchy is mapped to the table in order to identify the appropriate table. In this case, that would mean identifying the table that is connected to the highest level element or attribute whose value is given, which in this case happens to be the ImageCategory element (420). The foreign key for this table is identified and that leads us to the ImageObject table which has the corresponding primary key, which in turn determines the appropriate objects (422).

Once the table is identified, the table is searched for the corresponding element and attribute values that are specified (428). The actual search is done by converting the XPath query substring as an advanced search using SQL as described above which returns a set of images (424).

If there are more than one image matches (430), then a determination is made as to whether there is if further information provided. If there is further information, additional queries are made. Towards that, if an example image is given, the color and texture parameters are extracted and the Euclidean distance is computed between the color and texture parameters of the example image and that of the retrieved images (508). The first N best matches are shown to the user (512, 514). At this point the user can choose either one of the images that best portray his selection (516). This image, then, replaces the example image and the search is repeated and then again the best N matches among the selected images via the XML database search are repeated. The primary purpose of this step is to give the user the ability to qualify his search for properties that might not be easily describable.

Having described embodiments for a method for associating a text XML file with an image document, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

1. A method of creating an Extensible Markup Language (XML) file that is associated with an image document comprises the steps of:
a). creating a Document Type Definition (DTD) that defines a hierarchy for the XML file;
b). obtaining an image classification for the image document;
c). using image analysis processes to extract dominant parameters of the image document;
d). identifying an image category for the image document;
e). identifying at least one image sub-category for the image document;
f). extracting objects from the image; and
g). creating an XML file to store information obtained from steps b)-f).

2. The method of claim 1 wherein the DTD further comprises defining a root element in the XML file as AIUDoc.

3. The method of claim 2 wherein the AIUDoc comprises a name of the image document.

4. The method of claim 2 wherein the AIUDoc comprises ImageDocX.

5. The method of claim 4 wherein ImageDocX includes texture parameters for the image document.

6. The method of claim 4 wherein ImageDocX includes color parameters for the image document.

7. The method of claim 4 wherein ImageDocX includes object information.

8. The method of claim 7 wherein the object information comprises a location for the object.

9. The method of claim 7 wherein the object information comprises coordinate data for the object.

10. The method of claim 7 wherein the object information comprises reference information for the object.

11. The method of claim 1 further comprising the step of obtaining author information for the image document.

12. The method of claim 1 further comprising the step of obtaining date information for the image document.

13. The method of claim 1 wherein step c) further comprises the step of performing wavelet analysis on the image document.

14. The method of claim 1 wherein step c) further comprises the step of performing color histogram generation on the image document.

15. A method for querying Extensible Markup Language (XML) files to search for one or more image documents, the method comprising:
receiving a context-based query for an image document;
converting the context-based query to an XPath query;
mapping the XPath query to a Structured Query Language (SQL) string;
searching for one or more image documents using the SQL string;
retrieving one or more image documents that match search criteria in SQL string; and
displaying to a user the one or more retrieved image documents.

16. The method of claim 15 wherein the step of converting the context-based query to an XPath query further comprises the step of:
identifying a location for a start tag in the context-based query.

17. The method of claim 15 wherein the step of mapping the XPath query to a SQL string further comprises the steps of:
identifying a table containing a highest level attribute of the XPath query;
identifying a foreign key for the identified table; and
identifying a second table containing the appropriate objects by identifying the primary key based on the identified foreign key.

18. The method of claim 17 wherein the step of retrieving one or more image documents further comprises the step of:
extracting color and texture parameters for one or the retrieved image documents; and
calculating a Euclidean distance between color and texture parameters for an example image and color and texture parameters for the one retrieved image document.

19. The method of claim 15 further comprising the steps of:
receiving a selection of a retrieved image document from the user;
substituting an example image with the selected image document; and
searching for image documents using the selected image document and the SQL string.
